(19) United States
(12) Patent Application Publication
(10) Pub. No.: US 2004/0062298 A1
(43) Pub. Date: Apr. 1, 2004

(54) System and method for detecting direct sequence spread spectrum signals using pipelined vector processing

(76) Inventors: John G. McDonough, La Jolla, CA (US); Gibong Jeong, San Diego, CA (US); Karim Abdulla, San Diego, CA (US); Rajiv R. Nambiar, San Diego, CA (US); William S. Clark JR., Escondido, CA (US)

Correspondence Address: TEXAS INSTRUMENTS INCORPORATED, P O BOX 655474, M/S 3999, DALLAS, TX, 75265

(21) Appl. No.: 10/651,120

(22) Filed: Aug. 28, 2003

Related U.S. Application Data
(60) Provisional application No. 60/415,218, filed on Oct. 1, 2002.

(51) Int. Cl. H04B 1/707

(52) U.S. Cl. 375/150

(57) ABSTRACT

System and method for using pipelined vector processing in the detection of direct sequence spread spectrum signals. A preferred embodiment comprises a memory (such as memory 507) used to store a plurality of hypotheses, a PN sequence generator (such as PN generator 527) that can generate PN sequences for each of the hypotheses, and vector processing correlators and accumulators (both coherent and non-coherent). The PN sequence generator can arbitrarily generate PN sequences for any hypothesis, permitting the simultaneous testing of multiple hypotheses. A searcher controller (such as search control unit 319) can schedule access to different units in a pipelined fashion to increase the number of hypotheses tested in a given period of time.

This application claims the benefit of U.S. Provisional Application No. 60/415,218, filed on Oct. 1, 2002, entitled “Method and Apparatus for Detecting DS SS Signals Using Pipelined Vector Processing”, which application is hereby incorporated herein by reference.

### CROSS-REFERENCE TO RELATED APPLICATIONS

This application is related to the following co-pending and commonly assigned patent applications: Ser. No. ______, filed Aug. 28, 2003, entitled “System and Method for Detecting Multiple Direct Sequence Spread Spectrum Signals Using a Multi-Mode Searcher”; Ser. No. ______, filed Aug. 28, 2003, entitled “System and Method for Detecting Direct Sequence Spread Spectrum Signals Using Batch Processing of Independent Parameters”; Ser. No. 10/439,400, filed May 16, 2003, entitled “System and Method for Intelligent Processing of Results from Search of Direct Sequence Spread Spectrum (DSSS) Signals”; Ser. No. ______, filed Aug. 28, 2003, entitled “System and Method for Performing Symbol Boundary-Aligned Search of Direct Sequence Spread Spectrum Signals”, which applications are hereby incorporated herein by reference.

### TECHNICAL FIELD

The present invention relates generally to a system and method for digital communications, and more particularly to a system and method for using pipelined vector processing in the detection of direct sequence spread spectrum signals.

### BACKGROUND

In many modem wireless communications systems, for example, communications systems based upon third-generation code-division multiple access (CDMA) such as CDMA2000 (also known as IS-2000) and UMTS WCDMA (Universal Mobile Telephony System Wideband-CDMA or simply UMTS), each cell sites (or base stations) or base station sectors may use a different time offset of scrambling codes that may be used to identify the cell site or sector. Therefore, in order to establish a communications link between a mobile station and a cell site (or sector), the mobile station should search for a cell site and determine a frame synchronization offset for the cell site. The process of searching for a cell site and determining the frame synchronization offset for the cell site is commonly referred to as synchronization or acquisition. Additionally, in UMTS systems, the mobile station should also determine a downlink scrambling code. This is due to the fact that each cell site uses a different scrambling code.

To achieve synchronization, the mobile station may use a searcher unit to perform an initial cell site acquisition, cell site measurement, a delay profile estimation, and so forth. The mobile station begins by first acquiring the scrambling code, code offset, and carrier frequency of the strongest cell site. The mobile station can then measure the link quality of radio links of neighboring cell sites. This step may be used to support various forms of handoff. Then, the mobile station can estimate the delay profile in order to perform an allocation of rake receiver fingers or demodulator elements. The role of the searcher unit can be described as testing a hypothesis that a spread spectrum signal (for example, the radio link to a neighboring cell site) exists at a particular code offset and/or at a certain carrier frequency and/or with a certain scrambling code.

The synchronization requires a searcher unit with a high throughput, since a time to synchronization is one of the more critical performance metrics of a mobile station at power-up. Also, the mobile station may be required to measure a large number of neighboring cell sites. Furthermore, the mobile station may also be required to monitor the multipath profile for the frequency of an existing radio link so that the rake receiver fingers can be assigned to newly found strong multipath components with little or no latency. In addition to the throughput requirement, the parameters of the searches can be different from one cell site to another and from one search instance to another. For example, search parameters may include but not limited to hypotheses, pilot channel types, coherent dwell time, noncoherent dwell time, search window size, search resolution, and so forth.

A prior art design for a searcher unit correlates I and Q samples from a received signal with a locally stored scrambling code in serial fashion wherein one hypothesis is tested at a time. The prior art design features a simple correlator that is easy to create and can operate at very high frequencies, offsetting its sequential operation.

Another prior art design for a searcher unit uses a parallel design wherein multiple hypotheses (code offsets) are tested simultaneously. The parallel design permits the testing of several hypotheses at one time, hence increasing the total number of hypotheses that can be tested for a given period of time. The parallel design can make use of a simple correlator design, permitting high frequency operation.

One disadvantage of the prior art is that the prior art designs require high operating frequencies to ensure that sufficient numbers of hypotheses can be tested within an allotted amount of time. The high frequency operation may require that the searcher units, specifically, the correlators, be created from more expensive fabrication technologies. This may possibly lead to a more expensive mobile station. Furthermore, the high frequency operation may result in greater power consumption, which can lead to shorter battery life for the mobile station.

A second disadvantage of the prior art is that the serial design for the searcher unit may involve a significant amount of software control for processing of intermediate results.

A third disadvantage of the prior art is that the parallel design for the searcher unit may impose certain restrictions on the use of the correlator. For example, the parallel correlators must start and stop operation in synchrony. Additionally, the code offsets being tested may need to be contiguous due to the use of a serial code generator that uses linear shift registers. Since the code offsets need to be contiguous, the hypotheses may be referred to as being dependent hypotheses.

### SUMMARY OF THE INVENTION

These and other problems are generally solved or circumvented, and technical advantages are generally achieved, by preferred embodiments of the present invention.

In accordance with a preferred embodiment of the present invention, a method comprising receiving a vector of hypotheses, generating a pseudo-random number (PN) sequence for each hypothesis in the vector of hypotheses, correlating a received sequence with each PN sequence, and accumulating the results of the correlation for each sequence.

In accordance with another preferred embodiment of the present invention, a searcher comprising a vector despreader coupled to a sample input, the vector despreader containing circuitry to correlate a plurality of pseudo-random number (PN) sequences with a received sequence provided at the sample input, a vector accumulator coupled to the vector despreader, the vector accumulator containing circuitry to perform coherent and non-coherent accumulation of the correlation performed in the despreader, and a results processor coupled to the vector accumulator, the results processor containing circuitry to search the accumulations performed by the vector accumulator to find successful correlations.

In accordance with another preferred embodiment of the present invention, a wireless receiver comprising an analog front end coupled to an antenna, the analog front end containing circuitry to filter and amplify a received signal provided by the antenna, an analog-to-digital converter (ADC), the ADC to convert an analog signal provided by the analog front end into a digital symbol stream, and a digital signal processing section coupled to the ADC, the digital signal processing section containing circuitry to synchronize the wireless receiver with a communications network.

An advantage of a preferred embodiment of the present invention is that multiple independent hypotheses may be correlated, permitting the testing of different portions of a pseudo-random number (PN) codespace at the same time. Independent hypotheses are hypotheses that may have code offsets that have no relation with one another, i.e., the code offsets may be dispersed throughout the PN codespace with no restriction.

A further advantage of a preferred embodiment of the present invention is that through vector processing a plurality of correlations may be performed in a single chip time (chip period), greatly increasing the number of hypotheses that may be tested within a given amount of time.

Yet another advantage of a preferred embodiment of the present invention is that through the use of pipelined stages, the correlation process may be further accelerated by having correlations complete every clock cycle.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram of an exemplary wireless communications system;

FIG. 2 is a diagram of a prior art searcher;

FIG. 3 is a diagram of a portion of a wireless receiver with a vector processing searcher, according to a preferred embodiment of the present invention;

FIG. 4a is a diagram of data flow in a vector processing searcher, according to a preferred embodiment of the present invention;

FIG. 4b is a diagram of an exemplary vector of hypotheses, according to a preferred embodiment of the present invention;

FIG. 5a is a diagram of a pipelined vector processing searcher, according to a preferred embodiment of the present invention;

FIG. 5b is a time-space diagram of a possible scheduling of the pipeline stages in a pipelined vector processing searcher, according to a preferred embodiment of the present invention;

FIG. 6 is a diagram of a process that can be used to control the operation of a pipelined vector processing searcher, according to a preferred embodiment of the present invention; and

FIG. 7 is a diagram of a wireless device with a pipelined vector processing searcher, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a wireless communications network that may be compliant to the CDMA (IS-95), CDMA2000, and the UMTS (Universal Mobile Telecommunications System) technical standards. An overview of the CDMA2000 technical standard is provided in a document entitled “Introduction to CDMA2000 Spread Spectrum Systems, Release 0,” which is herein incorporated by reference. An overview of the UMTS technical standard is provided in a document entitled “3^{rd} Generation Partnership Project; Technical Specifications Group Services and System Aspects General UMTS Architecture (Release 4),” which is herein incorporated by reference. The invention may also be applied, however, to other digital wireless communications systems which uses specific coded signals to identify base stations and which require that mobile stations acquire these coded signals prior to initializing communications.

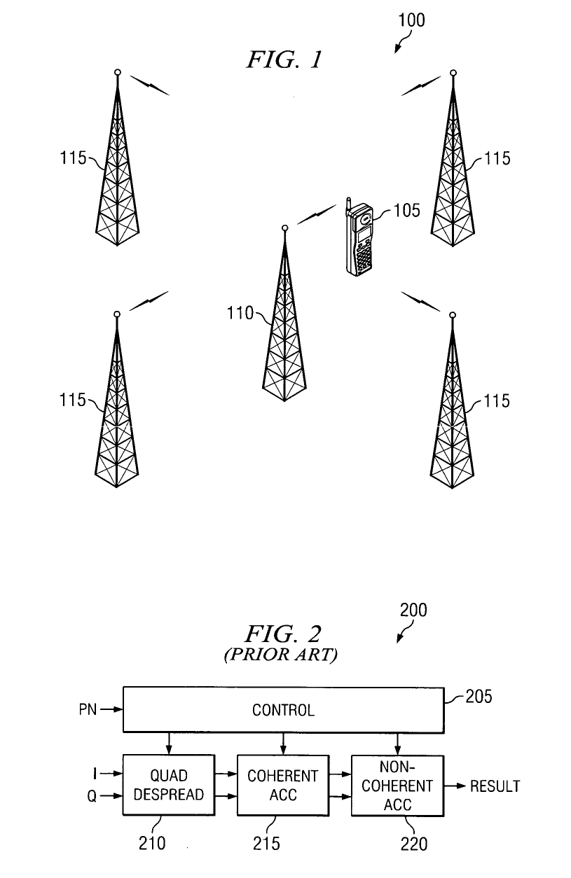

With reference now to FIG. 1, there is shown a diagram illustrating an exemplary wireless communications system 100. In the wireless communications system, there may be a mobile station 105 that is communicating with a base station 110. In addition to the base station 110, there may be a plurality of other base stations 115, which may be further away from the mobile station 105 than the base station 110. The mobile station 105, upon power-up, was able to synchronize with a signal from the base station 110 and hence began using the base station 110 to connect to the wireless communications system 100.

As discussed previously, in a code-division multiple access (CDMA) wireless communications system, such as an IS-95, CDMD2000, or UMTS compliant system, a mobile station is required to become synchronized with a base station upon power-up. The synchronization process requires that the mobile station perform a plurality of correlations of various offsets of a locally stored pseudo-random number (PN) sequence with a received signal. The correlation may also involve the application of various scrambling codes. Furthermore, the mobile station may be required to test received signals at various carrier frequencies.

The synchronization of the mobile station to a base station is normally performed in a portion of the mobile station commonly referred to as a searcher. The searcher receives as input, the received signals detected by the mobile station, usually in the form of a pair of sequences, I and Q. The searcher then correlates the I and Q sequences with a locally stored PN sequence set at a particular offset. The offset is commonly referred to as a PN offset and the process of correlating the received sequences with the PN sequence is commonly referred to as testing a hypothesis.

With reference now to FIG. 2, there is shown a block diagram illustrating a functional view of a prior art searcher 200 for a mobile station. As discussed previously, a primary function of the searcher 200 is to synchronize a mobile station to a base station. The searcher 200 helps in this process by testing various hypotheses against a received signal and producing a value that can be used to assist in synchronization. A hypothesis is typically a value for a PN sequence offset, although in certain communications systems, a hypothesis may involve carrier frequencies and scrambling codes as well.

Based on a particular PN offset for a given hypothesis, the searcher 200 may be provided (or it may generate its own) sequence of values corresponding to the PN sequence with the particular PN offset. A searcher control unit 205 may be responsible for functions such as the generation of the sequence of values amongst other things. Alternatively, the PN sequence may have been stored in a memory (not shown) and then, based on the particular PN offset, the sequence of values may have been determined from the memory.

The received signal, usually in the form of two sequences (an I and a Q sequence), may be provided to a quadrature despread unit 210, wherein the searcher 200 may remove any spreading placed onto a transmitted data prior to being transmitted. The transmitted data may be spread via the use of a code (referred to as a spreading code) to help improve the communications system's performance in the presence of interference. Additionally, the transmitter may use antenna diversity schemes to further improve the communications system. The quadrature despread unit 210 is responsible for extracting the transmitted data from the received signal.

The transmitted data may then be provided to a coherent accumulator 215, wherein the received data may be correlated with the sequence of values provided to the searcher 200. Correlation may be as simple as multiplying a value from the received signal with a corresponding value from the sequence of values and the product is summed. If there is a good match, then the summation result has a large magnitude. If there is a poor match, then the summation result has a small magnitude.

In addition to coherent accumulation, the received signal undergoes non-coherent accumulation in a non-coherent accumulator 220. Non-coherent accumulation involves the summation of the squares of the received sequences (I²+Q²) and does not consider any associated phase information. Finally, the result of the correlation for the particular hypothesis may be produced at the output of the non-coherent accumulator 220 and can be used by other circuitry not displayed to help the mobile station become synchronized with a base station.

As discussed earlier, prior art implementations of searchers, may use serial (sequential) processing units, such as a quadrature despreader 210, coherent accumulator, and non-coherent accumulator. Being serial in nature, the searcher must complete a correlation prior to starting another. Advancements in searcher design have brought about the use of parallel processing units which permit the correlation of multiple hypotheses at one time. Parallel processing units can improve the number of hypotheses tested within a given period of time. However, due to restrictions in PN sequence generation (amongst other things), searchers with the parallel processing are typically limited to testing hypotheses with adjacent PN offsets.

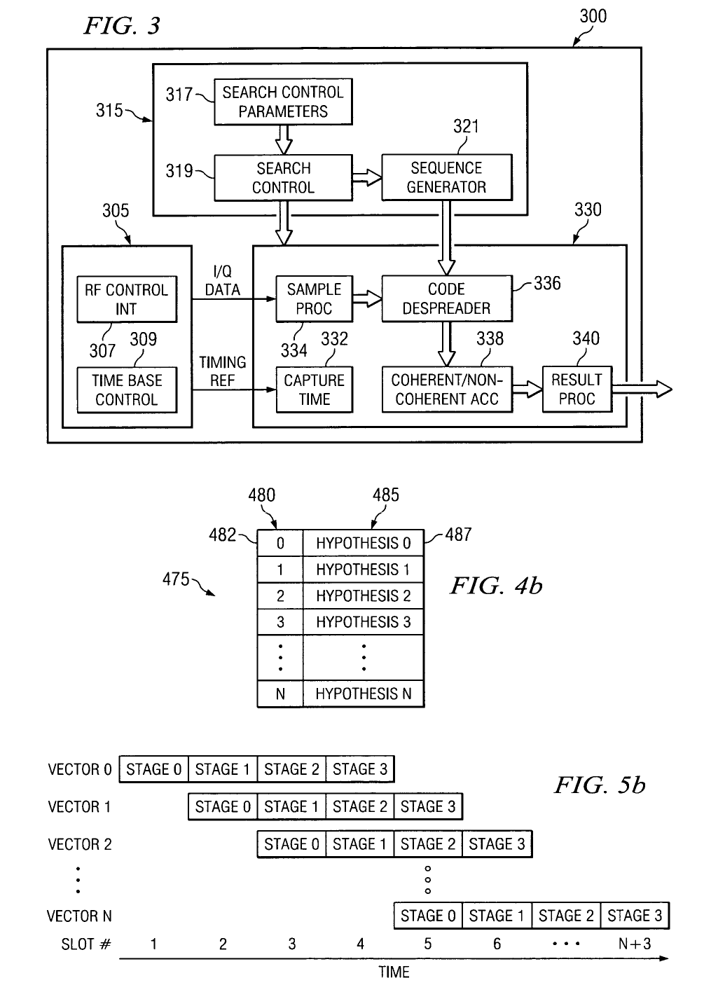

With reference now to FIG. 3, there is shown a block diagram illustrating a high-level view of a portion of a wireless receiver referred to as a search section 300, featuring a vector processing searcher 330 with vector processing, according to a preferred embodiment of the present invention. The search section 300 includes the vector processing searcher 300, a searcher controller 315, and a radio frequency (RF) receive section 305. The RF receive section 305 may be responsible for functions such as radio control and time base control and correction among other things. The radio control may be performed by a RF control interface 307, which can be used to control the functionality of a radio section (not shown) of the wireless receiver. The RF control interface 307 may be used to control the radio section so that a signal transmitted over-the-air may be received and subsequently processed and transformed in such a way that the received signal can be processed by other sections of the wireless receiver. According to a preferred embodiment of the present invention, the received signal may be presented to the other sections of the wireless receiver in the form of two data sequences, an I and a Q sequence. Time base control and correction may be performed by a time base controller 309, whose function may include the generation of a timing reference signal, clock recovery and/or generation, and so forth.

The searcher controller 315 may be responsible for controlling the operating of the vector processing searcher 330 as it relates to the search for specific signals. The searcher controller 315 includes a search control parameters section 317, a search control unit 319, and a sequence generator 321. The searcher controller 315 may be an interface between a processing unit (not shown) of the wireless receiver, such as a digital signal processing unit (DSP), a processing element, a central processing unit, a micro-controller, an application specific integrated circuit (ASIC), or so forth, and hardware specifically designed to implement the search process. As such, the searcher controller 315 may include both hardware and software components. For example, the search control parameters section 317 may be a memory that can be used to store specific search parameters requested by the processing unit, while the search control unit 319 may be a software program or a dedicated hardware circuit that may be used to configure the operation of the vector processing searcher 330 depending upon the search parameters from the search control parameters section 317.

The sequence generator 321 may be used to generate PN sequences used to correlate against the received sequences (I and Q sequences). The sequence generator 321, upon receiving control information from the search controller 319 may generate a PN sequence of a specified length, for example, 16 PN values. Note that the sequence generator 321 may be able to generate PN sequences of any length and that 16 was chosen since it gives good correlation results while minimizing overall PN sequence length. For example, the search controller 319 may provide the sequence generator 321 with a PN offset and the sequence generator 321 can generate a length 16 PN sequence based on the PN offset.

According to a preferred embodiment of the present invention, the sequence generator 321 may be provided with a plurality of PN offsets at a given time. Additionally, the sequence generator 321 does not require that the PN offsets be consecutive, i.e., the supplied PN offsets can be random offsets within the PN sequence. The sequence generator 321 may be constructed from a memory (not shown) that can be used to store necessary information needed to generate the requested PN sequences and a computational unit (not shown) that can be used to perform necessary computations (such as additions and multiplications) to generate the actual values in the requested PN sequences.

In order to support both UMTS and CDMA2000, the sequence generator 321 may need to generate several different types of PN sequences. For example, in UMTS, the sequence generator 321 would need to generate PN sequences referred to as Gold Codes while for CDMA2000, the PN sequences used are known as maximal length codes (or m-codes). Gold Codes and m-codes are considered well understood by those of ordinary skill in the art of the present invention.

A traditional method used for the generation of Gold Codes involves the use of two linear feedback shift registers (LFSR) of nominal 18 bit length, with each having different polynomials and initial states. Then, for a Gold Code of index N (an integer value), one of the two LFSRs is shifted by N while the other remains unshifted. This provides an offset of N between the two LFSRs. Each LFSR then outputs a single bit that is the result of an XOR (exclusive-OR) operation of the 18 bits in the LFSR. The single bit from each LFSR is then XOR'ed together to produce a single Gold Code PN bit of index N. Using this technique, any arbitrary Gold Code PN bit can be obtained by shifting both LFSRs by the same amount.

According to a preferred embodiment of the present invention, Gold Code PN sequences may also be generated using matrix multiplication techniques. By writing each of the two 18-bit LFSRs in its Fibonacci form, the output bit of the LFSR is simply the least significant bit (LSB) of the LFSR state (as opposed to the XORing the 18 state bits together). An advantage in using the Fibonacci form of the LFSRs is that the next output bit is the LSB of the LFSR after a single bit shift. This may be due to the fact that the only bit which may change value on a single shift is the most significant bit (MSB). Other bits simply transition down the chain towards the LSB. Since it is preferred that the sequence generator 321 provide a length 16 PN sequence, the entire 16 value PN sequence can be available at one time.

To further reduce the number of computational and storage requirements of the sequence generator 321, a property of LFSR state values state that any given LFSR state that can be expressed as a multiplication of two or more other states can be written as a sum of these two or more states. For example, should it be desired to generate an LFSR state for state 299, then state 299 may be expressed as a multiplication of state 256 and state 32 and state 8 and state 2 and state 1. Therefore, any state of the 18-bit LFSR can be created via a maximum of 17 multiplications. However, since the UMTS technical standard specifies a possible range of states from zero (0) to 38399, only the constant values for 16 states may be needed to be stored. Then, to generate a Gold Code PN sequence, the sequence generator 321 may need the following information: the Gold Code index (i.e., N) and the number of times that the two LFSRs are shifted.

The generation of OVSF/Walsh PN sequences is more straight-forward. Since according to the CDMA2000 technical standard, a wireless station is only required to synchronize to a Primary Common Pilot Channel (P-CPICH) which is always assigned OVSF/Walsh “0” over a Spreading Factor of 256. Therefore, a typical way to generate an OVSF/Walsh “0” PN sequence with a Spreading Factor of 256 would be to simply store a 256×256 Hadamard matrix in tabular form. However, to save storage space, the sequence generator 321 can store a 16×16 Hadamard matrix in tabular form. This is due to a property of Hadamard matrices which states that larger Hadamard matrices can be constructed from smaller Hadamard matrices. The use of a Hadamard matrix to generate OVSF/Walsh PN sequences is considered well understood by those of ordinary skill in the art of the present invention. Then, to generate an OVSF/Walsh PN sequence, the sequence generator 321 may need the following information: Spreading Factor (although in CDMA2000, it is fixed at 256), OVSF/Walsh index (varies from 0 to 511), and PN index.

The vector processing searcher 330 may be used to correlate PN sequences generated by the sequence generator 321 with the received sequences I and Q. The vector processing searcher 330 may receive control signals from the search controller 319 such as the PN offsets of the hypotheses that the pipelined searcher 330 should correlate, start and stop signals, and so forth. The vector processing searcher 330 can also be used to actually control the generation of the PN sequences by the sequence generator 321. For example, the PN offsets provided to the vector processing searcher 330 by the search controller 319 may be converted into hypotheses by the vector processing searcher 330 and then provided to the sequence generator 321, which may then produce the 16 value PN sequences for each of the hypotheses.

The vector processing searcher 330 may include a sample processor 334, a code despreader 336, a coherent/non-coherent accumulator 338, and a results processor 340. The sample processor 334 may have as an input, the received data (the I and Q sequences) provided by the RF receive section 305. The sample processor 334 may be used to provide an oversampled stream of values from the I and Q sequences. According to a preferred embodiment of the present invention, the sample processor 334 may oversample the I and Q sequences by a factor of 4, creating 4 samples of each I and Q value. The multiple samples of the I and Q values may be combined to help increase the quality of the I and Q values used in the correlation.

Output of the sample processor 334 may then be provided to the code despreader 336, wherein they may be stored in memory (not shown) located in the code despreader 336. The code despreader 336 may be used to reverse any antenna diversity applied to the transmitted signal at the time of transmission.

The output of the code despreader 336 may then be provided to the coherent/non-coherent accumulator 338, wherein the results of the correlation are calculated and maintained. Coherent accumulation is the summation of individual multiplications of the received sequences (I and Q) with the generated PN sequence which takes into consideration the phase of the signals, while non-coherent accumulation is the summation of the individual multiplications of the received sequences with the generated PN sequence without taking into consideration the phase of the signal. Coherent and non-coherent accumulation is considered well understood by those of ordinary skill in the art of the present invention.

After the coherent and non-coherent accumulation is complete for a correlation (all 16 PN sequence values have been multiplied with the received sequence and the respective accumulations updated), the result of the correlation may then be provided to the results processor 340 wherein the correlation results may be processed to determine if a match has occurred between the received sequence and the PN sequence (i.e., if a hypothesis has proven to be good). For a more detailed description of the operation of a result processor, please refer to a co-pending and co-assigned patent application entitled “Method and System for Intelligent Processing of Results from Search of Direct Sequence Spread Spectrum (DSSS) Signals”, filed “______ 2003”, serial number “______”, which is herein incorporated by reference.

In addition to the circuitry discussed above, the vector processing searcher 330 may also include a capture time unit 332, which may be used to provide timing information to the sequence generator 321. For example, the captured time may serve as a time reference for the searcher to correlate relative to. In CDMA2000, this notion of time is consistent amongst all mobile stations, whereas in UMTS, each mobile has its own independent notion of time.

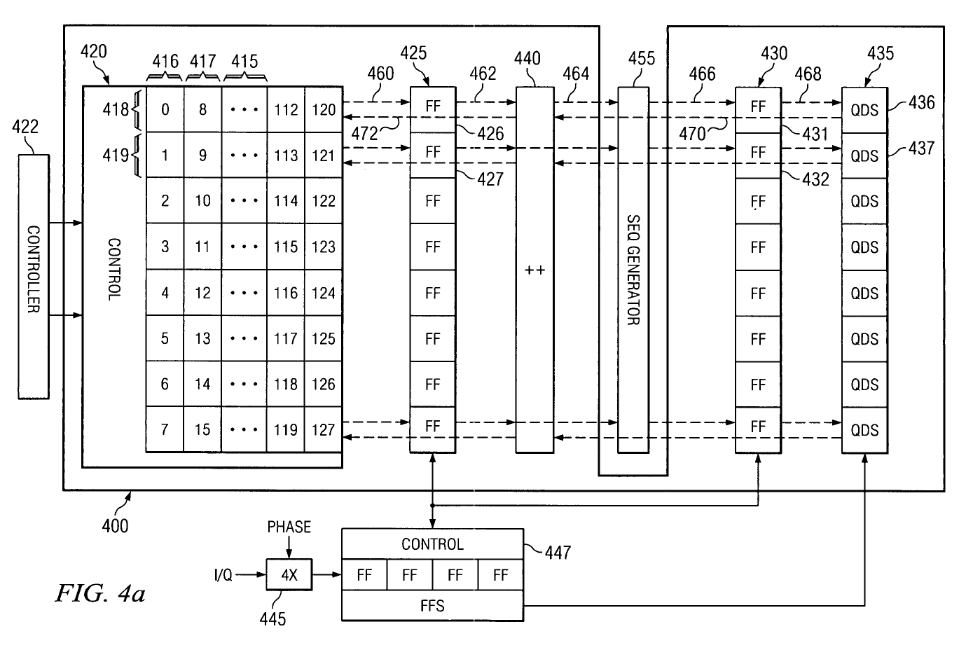

With reference now to FIG. 4a, there is shown a block diagram illustrating data flow in a portion of a vector processing searcher 400 with a sequence generator 455, according to a preferred embodiment of the present invention. As displayed in FIG. 4a, the vector processing searcher 400 is configured to operate on 128 independent hypotheses with 16 correlations at a time for each hypothesis. Note however, that the vector processing searcher 400 may be adjusted to operate on a different number of independent hypotheses correlations with minor adjustments. Note that 64 independent hypotheses (16 at a time), 64 independent hypotheses (8 at a time), 256 independent hypotheses (16 at a time), 256 independent hypotheses (32 at a time), 32 independent hypotheses (8 at a time), and so forth are only a few examples out of the many possible configurations for the vector processing searcher 400.

The vector processing searcher 400 features a memory 415 that may be logically arranged into matrix form (rows×columns), for example, columns 416 and 417 and rows 418 and 418. As configured to process 128 independent hypotheses, 16 correlations at a time for each hypothesis, the memory 415 may be logically configured as a matrix of 8 rows×16 columns. Note that the arrangement of the memory 415 (an 8 row×16 column matrix) can change depending upon the design of the vector processing searcher 400. For example, should the number of simultaneous correlations change or the number of independent hypotheses change, then a change may be suggested for a different configuration for the memory 415. Each element in the memory 415 (for example, the memory element addressed by row 418 and column 416) may be used to store a hypothesis along with associated information. The memory element may also be used to store coherent and non-coherent accumulation, the correlation value, the PN sequence corresponding to the hypothesis (as generated by the sequence generator 455), and so forth. The memory 415 may include a memory controller 420 that can be used to control read and write access to the memory 415. The design of the memory controller 420 is considered well understood by those of ordinary skill in the art of the present invention.

A counter 422, coupled to the memory 415, can be used to maintain indexes into the memory 415 as well as pointers to memory columns being accessed. The counter 422 may maintain counts of various values such as hypothesis counter, column counter, sum write counter, index write counter, and so forth. In general, the counter 422 maintains pointers and indexes into different portions of the memory 415 to maintain the proper order in which the hypotheses are being correlated.

The vector processing searcher 400 may also include a first bank of flip flops 425 and a second bank of flip flops 430. The two banks of flip flops 425 and 430 can be present to provide synchronization of the data movement with the clock. The banks of flip flops 425 and 430 permit the sharing of hardware by the multiple hypotheses rather than requiring separate hardware for each of the hypotheses. Another use for the banks of flip flops 425 and 430 may be to provide stages of pipelining. Another function of the first bank of flip flops 425 may be to synchronize the flow of the data stored in the memory 415 with the operation of the sequence generator 455. The flow of the data stored in the memory 415 should be restricted until the sequence generator has been able to generate the requested PN sequences. The second bank of flip flops 430 may serve a similar function, but to synchronize the flow of the data with the operation of a despread unit 435.

The despread unit 435, shown in functional form in FIG. 4 as a plurality of despread units (for example, functional despread units 436 and 437). According to a preferred embodiment of the present invention, a single despread unit operating at a clock frequency sufficient so that in each chip period (the inverse of the chip rate, 1.2288 MHz for CDMA2000 and 3.84 MHz for UMTS), the despread unit 435 can be time shared among the 16 hypotheses being correlated. Therefore, in eight chip periods, contents from the eight columns of the memory 415 are provided to the despread unit 435.

An adder unit 440 may be used to sum the correlations. According to a preferred embodiment of the present invention, the adder unit 440 may have a sufficient number of summation units to maintain a sum of the multiple correlations taking place simultaneously. For example, as configured to perform 128 independent hypotheses, 16 correlations at a time for each hypothesis, the adder unit 440 may be required to maintain the sum for 16 correlations at one time. The summations performed in the adder unit 440 may be used to generate the coherent and non-coherent accumulations performed by the vector processing searcher 400.

The received sequences (the I and Q samples) may then be provided to the vector processing searcher 400. According to a preferred embodiment of the present invention, the received sequences can be oversampled and then summed. This oversampling and summing can help improve the overall noise floor. For example, the received samples may be oversampled by a factor of four (by a sampler 445). The oversampling produces four samples for each I and Q value. Note that other oversampling factors may be used, such as two, eight, 16, and so forth. After being oversampled by a factor of four, two (or more) samples for each I and Q can be summed to produce a single I and Q value. Note that the oversampling and summing operations are not necessary operations and can be omitted without changing the operation of the vector processing searcher 400 or the present invention.

After being oversampled and summed, the I and Q samples may be correlated with each of the hypotheses being correlated. According to a preferred embodiment of the present invention, a single set of I and Q samples (16 samples of each) can be correlated against each of the 128 hypotheses being correlated.

A series of dashed lines (460 through 472) can be used to illustrate a flow of data through the vector processing searcher 400 and sequence generator 455 as it correlates multiple independent hypotheses. Note that data may flow from each of the memory locations within the memory 415, but to maintain clarity, the discussion will focus on a single memory location. Note also that the flip flops (such as banks of flip flops 425 and 430) are used to permit the sharing of hardware between the different hypotheses being correlated and to enable the various stages of pipeline. The discussion will omit the movement of the hypotheses and other data to and from the various flip flops.

A hypothesis, stored in a memory location (for example, memory location “0” addressed at row 418 and column 416), is moved from the memory 415 and is provided to the adder unit 440. Dashed lines 460 and 462 illustrate this movement. The adder unit 440 may be used to convert the hypothesis and the other information into a PN offset that can be used by the sequence generator 455 to produce a desired PN sequence.

A third dashed line 464 may indicate the movement of a PN offset being moved to the sequence generator 455 from the adder unit 440. After the hypothesis is provided to the sequence generator 455, the sequence generator 455 will generate a PN sequence corresponding to the specified PN sequence. According to a preferred embodiment of the present invention, the sequence generator 455 will generate a 16 value long PN sequence for each hypothesis.

After the PN sequence has been generated by the sequence generator 455, the PN sequence may be moved to the despreader unit 435 (dashed lines 466 and 468). In the despreader unit 435, the PN sequence will be correlated with the received I and Q. Note that the despreader unit implement an algorithm referred to as quadrature despreading (QDS). QDS is considered to be well understood by those of ordinary skill in the art of the present invention.

After correlation is complete, the correlated values may be provided back to the adder unit 440 (as indicated by a sixth dashed line 470) wherein the coherent and non-coherent accumulation values may be calculated. Finally, the accumulation values (both coherent and non-coherent) may be written back to the memory 415 (as indicated by a seventh dashed line 472) where it may be retrieved by a results processor (not shown). As discussed previously, the results processor can parse through the different correlation results to determine any correlation matches. A similar set of operations occur for the remaining memory locations in memory column 416 and for the remainder of the memory 415.

With reference now to FIG. 4b, there is shown a diagram illustrating an exemplary vector 475 of hypotheses usable by the vector processing searcher 400 (FIG. 4a), according to a preferred embodiment of the present invention. The vector 475 may include a series of indices 480 and hypotheses 485. The indices may be used to enumerate the hypotheses and provide a reference number that can be used to access other information, such as correlation status, correlation result, accumulation values, and so forth.

According to a preferred embodiment of the present invention, a clock used to control the operation of the vector processing searcher is 16 times the chip rate. For CDMA2000, the chip rate is 1.2288 Mhz and for UMTS, the chip rate is 3.84 Mhz. This means that in the time equal to a single chip period, the vector processing searcher 400 has been clocked a total of 16 times. Through the use of a high frequency clock, the vector processing searcher 400 can timeshare the despread circuitry, the coherent accumulation circuitry and the noncoherent accumulation circuitry. Therefore, in a single chip time, the vector processing searcher 400 can correlate all of the hypotheses stored in a single column of the memory 415. Note that the 16 times clock multiplier is an implementation decision based on the number of hypotheses that the designer wanted to correlate and that other values of clock multiplier, such as two times, four times, eight times, and so forth may be usable without requiring much change to the preferred embodiment of the present invention.

Additionally, a small delay may be present at the beginning of the vector processing operation in order for the 16 chips of I and Q samples to be received. This delay can correspond to a 256 cycle delay (16 chip*16 cycle/chip). Note however that this is a startup delay and has no impact on the throughput of the vector processing searcher.

The use of vector processing (versus serial processing) in the vector processing searcher 400 can greatly increase the number of quadrature despreads per chip time. For example, in the design for the vector processing searcher 400 discussed above, 128 hypotheses can be correlated and accumulated in a total of 64 chip periods (128 hypotheses can be correlated and accumulated in a total of 16 chip periods, however, since there are effectively four functional units in the vector processing searcher 400, with each independently processing all 128 hypotheses, the total time is 16 chips/functional unit*4 functional units=64 chips). A serial searcher would require 128 chips to process all 128 hypotheses, at a rate of 1 hypothesis per chip.

Pipelining is a commonly used technique in processor design to help improve the performance of the processor. Pipelining involves the use of multiple functional units that can be scheduled consecutively so that each functional unit is busy every clock cycle. So rather than having a single operation move from one functional unit to another with the remaining functional units sitting idle, pipelining breaks the operations into multiple functional unit operations that keeps the functional units busy by scheduling a functional unit to work on a subsequent operation prior to the current operation completing. For example, if an operation uses four functional units and each functional unit takes a clock cycle to complete, then it could take four clock cycles for the instruction to complete. Therefore, if there are 10 such instructions, then it would take 40 clock cycles for all 10 instructions to complete. However, through pipelining, the 10 instructions could complete in 13 clock cycles. Instruction pipelining is considered well understood by those of ordinary skill in the art of the present invention.

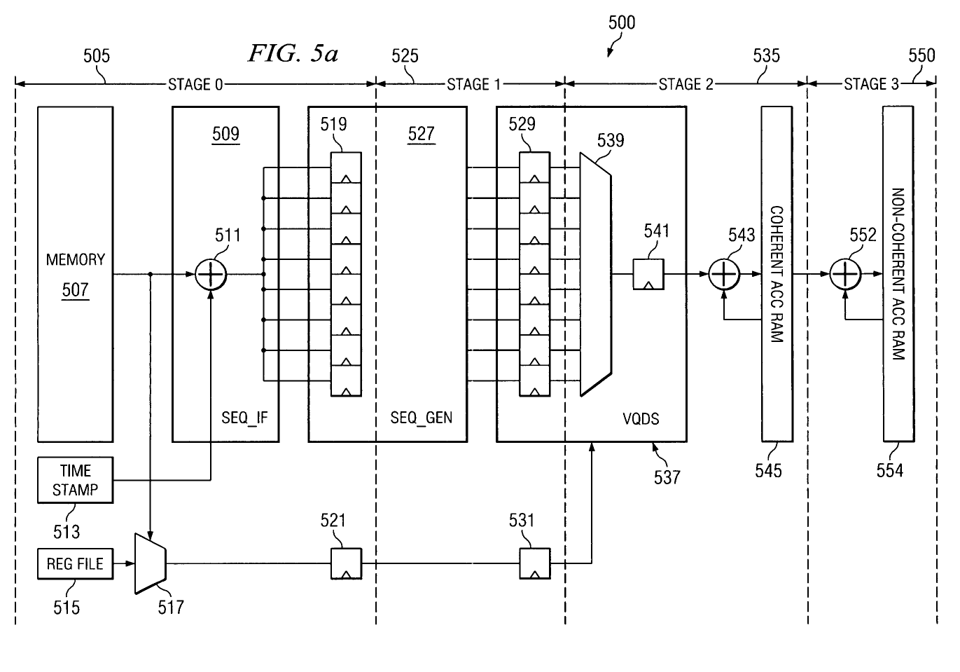

With reference now to FIG. 5a, there is shown a diagram illustrating a pipelined vector processing searcher 500, according to a preferred embodiment of the present invention. The pipelined vector processing searcher 500 may be thought of as essentially a vector processing searcher (such as the vector processing searcher 400 (FIG. 4a)) with pipelining added to help further improve performance. The pipelined vector processing searcher 500 as displayed in FIG. 5 has four pipelined stages, however, the number of pipelined stages and the partitioning of the stages can vary, usually according to circuit timing issues and operating clock frequency.

A first stage of the pipelined vector processing searcher 500, referred to as stage “0” and encompassing an interval that is displayed as highlight 505, may be called a code offset generation stage. In the code offset generation stage, a hypothesis generator 509 reads a hypothesis stored in a memory 507. From the hypothesis, the hypothesis generator 509 can generate a code offset and a sampling offset. The hypothesis generator 509 may be constructed from a summation point 511 that combines the hypothesis read from the memory 507 with timing information from a time stamp unit 513.

The memory 507 may also contain other information that can be relevant to the operation of the pipelined vector processing searcher 500, such as hypothesis number, record number, and so forth. This information can be provided to a selection unit 517 that may be used to select a proper set of registers from a register file 515. The register file 515 can be a plurality of registers, only some of which may be seen in a single context. The registers that may be seen in a single context represents the entire set of registers that can be used in the context and the register file permits separate registers for each context without having to switch register contents in and out during execution.

According to a preferred embodiment of the present invention, the hypothesis generator 509 can be clocked at a rate that is greater than the chip rate so that it can generate more than one hypothesis in a single chip period. For example, referring back to the example used in the discussion of the vector processing searcher 400, wherein the vector processing searcher 400 is clocked by a factor of 16 greater than the chip period so that in each chip cycle, 16 independent hypotheses can be correlated. The hypothesis generator 509 can be clocked at a rate that can be equal to the number of independent hypotheses that the pipelined vector processing searcher 500 is expected to process in a single chip cycle.

The output of the hypothesis generator 509 may be stored in a bank of flip flops 519 as is the output of the selection unit 517 (in a flip flop 521). In addition to functioning as storage for the outputs of the hypothesis generator 509 and the selection unit 517, the bank of flip flops 519 and the flip flop 521) can also be used to allow synchronization points with the pipeline clock.

A second stage of the pipelined vector processing searcher 500, referred to as stage “1” and displayed in FIG. 5a as an interval marked as highlight 525, can be used to allow a sequence generator 527 to generate PN sequences corresponding to the information created by the hypothesis generator 509. The PN sequences generated by the sequence generator 527 can be stored in a second bank of flip flops 529.

A third stage of the pipelined vector processing searcher 500, referred to as stage “2” and displayed in FIG. 5a as an interval marked as highlight 535, may be used to perform the desired correlations and coherent accumulation. The correlations may be performed in a despread unit 537 while the results of the correlations are successively summed together in summing point 543 to produce a coherent accumulation of the correlation. The coherent accumulation may be stored in a coherent accumulation memory 545. According to a preferred embodiment of the present invention, the despread unit 537 implements a despread algorithm referred to as QDS (discussed previously).

A fourth stage of the pipelined vector processing searcher 500, referred to as stage “3” and displayed in FIG. 5a as an interval marked as highlight 550, may be used to perform non-coherent accumulation. As discussed previously, non-coherent accumulation is accumulation of the correlations without taking into consideration the phase information. In non-coherent accumulation, the correlation of the PN sequence with the I and Q sequences are squared prior to summation at a second summing point 552. The result of the non-coherent accumulation can be stored in a non-coherent accumulation memory 554.

Again, referring to the example of a searcher that permits the correlation of 128 independent hypotheses, 16 at a time, the vector processing searcher 400 may be able to complete the 128 correlations (and accumulations) in 64 chip periods. By adding pipelining, the pipelined vector processing searcher 500 may be able to complete the same 128 hypotheses correlations with accumulations in 19 chip periods (each independent functional unit takes 16 chips to process 128 hypotheses, the pipelining requires 3 chip periods to fill the pipeline stages).

With reference now to FIG. 5b, there is shown a time-space diagram illustrating an exemplary scheduling of a pipelined vector processing searcher with a four stage pipeline, according to a preferred embodiment of the present invention. FIG. 5b displays each of the four stages of pipelined vector processing searcher when the pipelined vector processing searcher is operating on N vectors. Note that each vector may contain one or more independent hypotheses. For example, in the example discussed above, each vector contains 16 independent hypotheses. Each vector requires processing by each of the four stages in the pipeline, with a stage beginning immediately after the previous stage completing.

For vector 0 (the first vector), in time slot 1, stage 0 is busy with stages 1, 2, and 3 being idle. In time slot 2, stage 1 is busy with stages 0, 2, and 3 being idle. Finally, in time slot 4, the final stage of processing for vector 0 begins. Note that in time slot 2, since stage 0 has completed the processing for vector 0, it becomes idle. Therefore, to help reduce idling, stage 0 can be assigned to process vector 1. In time slot 2, vector 0 has already been processed by stages 0 and 1, and vector 1 has already been processed by stage 0, so stage 0 can be assigned to process vector 2 and stage 1 can be assigned to process vector 1. This can continue until no additional vectors need processing. Note that more advanced pipelining techniques such as out-of-order processing may be added to further improve the performance of the pipelined vector processing searcher.

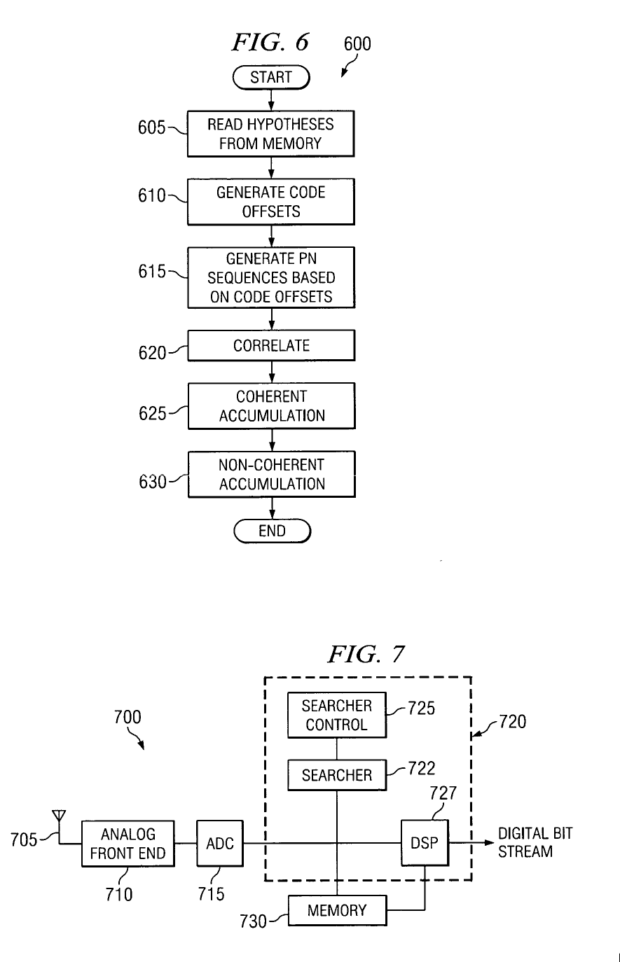

With reference now to FIG. 6, there is shown a flow diagram illustrating a process 600 that may be used to control the operation of a pipelined vector processing searcher 500 (FIG. 5a), according to a preferred embodiment of the present invention. According to a preferred embodiment of the present invention, the process 600 may be representative of a sequence of operations initiated by a search control unit (such as the search control unit 319 (FIG. 3)). The search control unit 319 may begin in block 605 by reading a first vector of hypotheses from memory (such as the memory 507 (FIG. 5a)).

With the first vector of hypotheses, the search control unit 319 may begin by scheduling a code offset generation stage (stage “0” (FIG. 5a)) to generate code offsets based on the hypotheses in the vector of hypotheses (block 610). The search control unit 319 may then schedule the processing of the first vector of hypotheses by subsequent stages of the pipelined vector processing searcher 500, such as PN sequence generation (block 615) in stage “1”, correlation and coherent accumulation (blocks 620 and 625) in stage “2”, and non-coherent accumulation (block 630) in stage “3”.

Once the processing of the first vector of hypotheses begins in stage “0”, the search control unit 319 may return to block 605 to retrieve a second vector of hypotheses. The search control unit 319 may then schedule stage “0” to begin processing the second vector of hypotheses once it completes processing the first vector of hypothesis. The process 600 can be until all vectors of hypotheses stored in the memory 507 have been read out and scheduled and the hypotheses tested and results calculated.

With reference now to FIG. 7, there is shown a block diagram illustrating a wireless receiver 700 with a pipelined vector processing searcher 722, according to a preferred embodiment of the present invention. The wireless receiver 700 includes an analog front end 710 which receives signals received over-the-air by an antenna 705. The analog front end 710 may be used to filter the received signal to help eliminate out-of band noise and interference, equalize and amplify the received signal to bring the received signal to a power level that is suitable for processing, and so forth. An analog-to-digital converter (ADC) 715 converts the analog signal into its digital representation.

Digital symbols, as produced by the ADC 715, may then be provided to a digital signal processing unit 720. The digital signal processing unit 720 can be responsible for functions such as error detecting and correcting of the digital symbols, decoding and despreading the symbol stream, deinterleaving and depuncturing the symbol stream, and so on. The digital signal processing unit also includes the pipelined vector processing searcher 722 with its attendant searcher controller 725 to help the wireless receiver 700 become synchronized with base stations in rapid fashion. A digital signal processor (DSP) 727 or a generic processing element may be available to perform many of the tasks required of the digital signal processing unit 720 in software.

A memory 730 may be coupled to the digital signal processing unit 720 to provide storage. Alternatively, the memory 730 may be inside the digital signal processing unit 720 or there may be multiple memories, each coupled to different parts of the digital signal processing unit 720 to provide needed storage. Finally, a digital bit stream can be produced by the digital signal processing unit 720, intended for use by circuits and devices coupled to the wireless receiver 700. Examples of circuits and devices that may be coupled to the wireless receiver 700 may include audio and video circuitry, digital computers and personal digital assistants, multimedia devices, data and information networks, and so forth.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
receiving a vector of hypotheses;
generating a pseudo-random number (PN) sequence for each hypothesis in the vector of hypotheses;
correlating a received sequence with each PN sequence; and
accumulating the results of the correlation for each sequence.

2. The method of claim 1 further comprising determining a code offset for each hypothesis after the receiving.

3. The method of claim 2, wherein the code offset is determined from the hypothesis and a current time.

4. The method of claim 1, wherein the received sequence is received while the PN sequences are being generated.

5. The method of claim 4, wherein the received sequence is used in the correlations with all hypotheses in the vector.

6. The method of claim 4, wherein the received sequence is in the form of an I and a Q sequences.

7. The method of claim 1, wherein a plurality of vectors of hypotheses are stored in a memory, and wherein the method is repeated until all vectors of hypotheses are correlated and accumulated.

8. The method of claim 1, wherein there is a plurality of vectors of hypotheses, wherein the generating, correlating, and accumulating operates in a pipelined fashion for each vector of hypotheses.

9. The method of claim 8, wherein the accumulating comprises coherent and non-coherent accumulation, and wherein the generating, correlating and coherent accumulating, and non-coherent accumulating are stages of a pipeline.

10. The method of claim 8, wherein the method further comprises computing a code offset for each hypothesis, and wherein the computing, generating, correlating and coherent accumulating, and non-coherent accumulating are stages of a pipeline.

11. A searcher comprising:
a vector despreader coupled to a sample input, the vector despreader containing circuitry to correlate a plurality of pseudo-random number (PN) sequences with a received sequence provided at the sample input;
a vector accumulator coupled to the vector despreader, the vector accumulator containing circuitry to perform coherent and non-coherent accumulation of the correlation performed in the despreader; and
a results processor coupled to the vector accumulator, the results processor containing circuitry to search the accumulations performed by the vector accumulator to find successful correlations.

12. The searcher of claim 11, wherein each PN sequence correlated in the vector despreader may be different and is correlated with the same received sequence.

13. The searcher of claim 12, wherein each PN sequence is based on a hypothesis and the hypotheses may be independent.

14. The searcher of claim 11, wherein the searcher is overclocked by a factor of N so that N correlations can be performed by the vector despreader and N accumulations by the vector accumulator within a period of time equal to a single value of the received sequence, where N is an integer value.

15. The searcher of claim 14 further comprising a sample processor coupled to the vector despreader, the sample processor containing a storage space used to hold the received sequence while the plurality of PN sequences are being created.

16. The searcher of claim 15, wherein the sample processor oversamples each value of the received sequence and then combines several oversampled values together.

17. The searcher of claim 11, wherein the received sequence is initially transmitted over-the-air by a transmitter, and wherein the vector despreader further contains circuitry to remove the effects of spreading codes and antenna diversity applied to the received sequence when the received sequence was transmitted.

18. The searcher of claim 11, wherein the searcher is pipelined, and wherein the vector despreader and the vector accumulator are pipeline stages.

19. The searcher of claim 11, wherein the searcher is pipelined, and wherein the vector despreader, the coherent accumulation in the vector accumulator, and the non-coherent accumulation in the vector accumulator are pipeline stages.

20. A wireless receiver comprising:
an analog front end coupled to an antenna, the analog front end containing circuitry to filter and amplify a received signal provided by the antenna;
an analog-to-digital converter (ADC), the ADC to convert an analog signal provided by the analog front end into a digital symbol stream; and
a digital signal processing section coupled to the ADC, the digital signal processing section containing circuitry to synchronize the wireless receiver with a communications network.

21. The wireless receiver of claim 20, wherein the digital signal processing section comprises:
a searcher coupled to a sample input, the searcher comprising
a vector despreader coupled to a sample input, the vector despreader containing circuitry to correlate a plurality of pseudo-random number (PN) sequences with a received sequence provided at the sample input;
a vector accumulator coupled to the vector despreader, the vector accumulator containing circuitry to perform coherent and non-coherent accumulation of the correlation performed in the despreader;
a results processor coupled to the vector accumulator, the results processor containing circuitry to search the accumulations performed by the vector accumulator to find successful correlations;
a searcher controller coupled to the searcher, the searcher controller containing circuitry generate PN sequences and to schedule the operation of the searcher; and
a memory coupled to the searcher, the memory to hold vectors of hypotheses.

22. The wireless receiver of claim 21, wherein the searcher controller generates PN sequences based on hypotheses stored in the memory and a current time provided by the searcher.

23. The wireless receiver of claim 21, wherein the digital signal processing section further comprises a digital signal processor (DSP) to filter, error detect and correct, and decode the digital symbol stream.

24. The wireless receiver of claim 20, wherein the wireless receiver is part of a wireless device operating in a code-division multiple access (CDMA) network.

25. The wireless receiver of claim 20, wherein the wireless receiver is part of a wireless device operating in a CDMA2000 compliant network.

26. The wireless receiver of claim 20, wherein the wireless receiver is part of a wireless device operating in a universal mobile telephony system (UMTS) network.
